(19) United States
(12) Patent Application Publication
(10) Pub. No.: US 2022/0129792 A1
(43) Pub. Date: Apr. 28, 2022

(54) METHOD AND APPARATUS FOR PRESENTING DETERMINATION RESULT

(71) Applicant: FUJITSU LIMITED, Kawasaki-shi (JP)

(72) Inventor: Izumi NITTA, Kawasaki (JP)

(73) Assignee: FUJITSU LIMITED, Kawasaki-shi (JP)

(21) Appl. No.: 17/406,976

(22) Filed: Aug. 19, 2021

(30) Foreign Application Priority Data
Oct. 27, 2020 (JP) 2020-179683

(51) Int. Cl. G06N 20/00

(52) U.S. Cl. CPC G06N 20/00

(57) ABSTRACT

A computer-readable recording medium having stored therein a determination result presenting program executable by one or more computers, the program including instructions for calculating a first contribution of first data including multiple factors with respect to a first prediction result obtained by inputting the first data into a machine learning model; calculating, by referring to information associating a second contribution of second data including multiple factors with respect to a second prediction result obtained by inputting the second data into the machine learning model with a determination result by a user on the second prediction result, a similarity between a third contribution and a fourth contribution obtained by adjusting the first contribution and the second contribution in accordance with a first factor identified by the determination result, respectively; and controlling, based on the similarity, a priory of a determination result to be presented among determination results in the information.

### CROSS-REFERENCE TO RELATED APPLICATION

This application is based upon and claims the benefit of priority of the prior Japanese Patent application No. 2020-179683, filed on Oct. 27, 2020, the entire contents of which are incorporated herein by reference.

### FIELD

The present invention relates to presenting a determination result.

### BACKGROUND

A method for presenting a contribution of input-data to a prediction result of a machine learning model to a user has been known. A contribution is, for example, information (explanation result) indicating the degree to which multiple factors included in input-data have contributed to a prediction result. Hereinafter, the degree of a contribution of each factor to a prediction result is sometimes referred to as a “factor contribution”.

The presenting of a factor contribution allows the user, who is making a decision on the basis of a prediction result, to take into account, for example, which factor has contributed to the prediction result, thereby improving the accuracy in decision making.

For example, related arts are disclosed in Japanese Laid-open Patent Publication No. 2020-95398, Japanese Laid-open Patent Publication No. 2020-123164, and U.S. Patent Publication No. 2015/0379429.

### SUMMARY

According to an aspect of the embodiment, a non-transitory computer-readable recording medium have stored therein a determination result presenting program executable by one or more computers, the determination result presenting program including: an instruction for calculating a first contribution of first data including a plurality of factors with respect to a first prediction result obtained by inputting the first data into a machine learning model; an instruction for calculating, by referring to information associating a second contribution of second data including a plurality of factors with respect to a second prediction result with a determination result by a user on the second prediction result, a similarity between a third contribution and a fourth contribution, the second prediction result being obtained by inputting the second data into the machine learning model, the third contribution being obtained by adjusting the first contribution in accordance with a first factor identified by the determination result, the fourth contribution being obtained by adjusting the second contribution in accordance with the first factor; and an instruction for controlling, based on the similarity, a priory of a determination result to be presented among a plurality of determination results included in the information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a presenting screen outputted by a system;

FIG. 2 is a block diagram schematically illustrating an example of a functional configuration of a server according to an embodiment;

FIG. 3 is a diagram illustrating an example of an interpretation example database (DB) according to the embodiment;

FIG. 4 is a diagram illustrating an example of an operation of an output-information obtainer;

FIG. 5 is a diagram illustrating an example of a presenting screen;

FIG. 6 is a diagram illustrating an example of a presenting screen provided by an interpretation example presenter;

FIG. 7 is a diagram illustrating an example of an interpretation example presenting process;

FIG. 8 is a flowchart illustrating an example of an operation of an interpretation example accumulating process performed by the server according to the embodiment;

FIG. 9 is a flowchart illustrating an example of an operation of an interpretation example presenting process performed by the server according to the embodiment;

FIG. 10 is a flowchart illustrating an example of an operation of a similarity calculating process; and

FIG. 11 is a block diagram schematically illustrating an example of a hardware (HW) configuration of a computer that achieves the function of the server.

### DESCRIPTION OF EMBODIMENT(S)

In some cases, presenting of a contribution to a prediction result of a machine learning model does not suffice explanatory qualified for the user's decision making.

Hereinafter, an embodiment of the present invention will now be described with reference to the accompanying drawings. However, the embodiment described below is merely illustrative and is not intended to exclude the application of various modifications and techniques not explicitly described below. For example, the present embodiment can be variously modified and implemented without departing from the scope thereof. In the drawings to be used in the following description, the same reference numbers denote the same or similar parts, unless otherwise specified.

First, description will now be made in relation to a process of decision making based on a prediction result of a machine learning model. The following description assumes a case where a professional user having business knowledge makes a decision based on an explanation result on a prediction result by an explanatory AI (XAI; Explainable Artificial Intelligence).

By way of example, a system for decision making presents, to the user, a factor contribution of each factor to a prediction result on data (e.g., input-data about a certain customer, target instance) of a determination target, using the XAI. In addition, the system presents, to the user, data (case) having a factor contribution similar to that of a factor contribution related to the target instance from accumulate data of the past prediction results.

Examples of decision making are decisions of measures to deal with prediction results of cancellation (withdrawal) membership of a customer, leave and/or resignation of a job of an employee, and determining financial crediting. The following explanation assumes a case where a marketer, i.e., a user, draws up measures to detain a customer likely to cancel the membership against a prediction result, which predicts that the customer will cancel the membership.

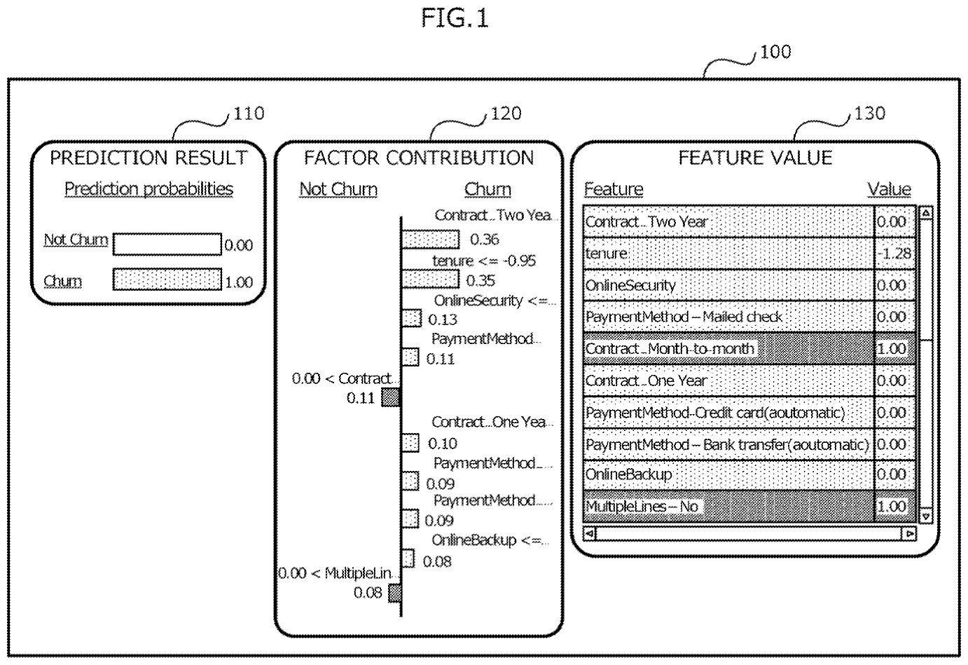

FIG. 1 is a diagram illustrating an example of a presenting screen 100 outputted by a system. The system predicts whether or not a customer will cancel the membership on the basis of an attributes of the customer and contents of the contract. For example, the system trains a machine learning model and makes a prediction by using gender, age, presence or absence of inmate, usage period, duration of contract, payment method, and using service of the customer as input-data (factors).

The system outputs the presenting screen 100 illustrated in FIG. 1. The presenting screen 100 may include a presenting area 110 of a prediction result of a target instance, a presenting area 120 of a factor contribution, and a presenting area 130 of a feature value.

Here, in the example illustrated in FIG. 1, the bar graphs and the cells illustrated in light hatching indicate the elements related to “Churn” (cancellation of membership), and the bar graphs and the cells illustrated in dense hatching indicate the elements related to “Not Churn” (no cancellation of membership). The same applies in the following description.

The presenting area 110 of the prediction result displays a prediction result of the machine-learning model based on input-data of a certain customer. The presenting area 110 illustrated in FIG. 1 presents the probability of “Churn” of “1.00” and the probability of “Not Churn” of “0.00”.

The presenting area 120 of the factor contribution displays ratios of contributions of respective input-data (factors) to the prediction of “Churn” or “Not Churn” in the descending order of percentage (from the higher contribution), for example.

The presenting area 130 of the feature value displays feature values of respective input-data (factors). Examples of the feature value may be parameters expressing factors such as gender, age, presence or absence of inmate, usage period, duration of contract, payment method, and using service of a customer in numerical values. As the above, the feature value is information that indicates the parameter of the factor, and also information that serves as the basis for a factor contribution. Consequently, the feature value may be regarded as information accompanying the factor contribution.

For example, the presenting area 130 illustrated in FIG. 1 presents that the feature value of the factor “Contract_Two year” (two-year contract) is “0.00” (e.g., not applicable; False). The presenting area 120 presents that the contribution of “Contract_Two year” (two-year contract) to the prediction of “Churn” is “0.36” because the feature value does not indicate two-year contract.

On the basis of the presenting screen 100 illustrated in FIG. 1, the user reads the main factor of a reason for the cancellation of membership from the factor contributions and the feature values for each instance and determines the reason for the cancellation.

For the reading of one or more main factors (cancellation main factors) for the cancellation of membership, the business knowledge exemplified by the proficiency, experience, knowledge amount of the user, is sometimes important. Therefore, depending on the user's business knowledge, it may be difficult to read the cancellation main factor, in other words, the accuracy of the user's decision making based on the prediction result may be lowered.

As an example, since multiple factors having the same degree of contribution are present in the presenting area 120 illustrated in FIG. 1, it may be difficult for a non-skilled user to determine which factor is the main factor in cancellation.

In contrast to the above, a skilled user, for example, can read the following main factors, as a cancellation main factor on the top, from the factor contributions of about four top factors. In the following main factors, “→ (arrow)” indicates an interpreting process of the skilled user.
“Contract_Two year”≤“0.50” (threshold), feature value “0.00”
   It is not a two-year contract.
   It is a short-term contract.
“tenure” (usage period)≤“−0.94” (threshold), feature value “−1.28”
   The usage period is short.
   It is a new customer.
“OnlineSecurity”≤“0.50” (threshold), feature value “0.00”
   The customer does not contract Online security.
“PaymentMethod_Mailed_check”≤“0.50” (threshold), feature value “0.00”
   The payment method is not by check.

From the above main factors, the skilled users finds that a new customer on a short-term contract easily cancels the membership, that a customer that pays not by check can easily cancel the membership, that a measure is needed for a customer with a usage period of less than X months (where X is an integer or a real number) to continue the service. In this manner, the skilled user determines (interprets) a reason for cancellation, considering two main factors that the customer is on a short-term contract and is a new customer in addition to the read cancellation main factors, and draws up a measure to detain the customer (i.e., decision making).

In cases where factor contributions are presented for decision making based on a prediction result of the machine learning model as the above, a task that the user interprets the reason for the prediction result from the factor contributions, using his/her business knowledge is generated. In other words, some cases of presenting factor contributions do not suffice the explanation for decision making.

An example of the above case is one described with reference to FIG. 1, i.e., a case where the presence of multiple factors having the same degree of factor contributions makes the user difficult to determine the main factor that determines the prediction result. Another example is a case where a factor having the maximum factor contribution does not coincide with a factor that the user interprets as an important factor.

As a solution to the above, one embodiment will describe a method for presenting appropriate information to be used for user's decision making based on a prediction result of a machine learning model. This method can reduce the labor of the user to read the explanation result to a prediction result of the machine learning model, for example.

For example, an apparatus for presenting a determination result according to the one embodiment executes the following processes (a) to (c).

(a) The apparatus for presenting the determination result calculates a first contribution of first data including multiple factors to a first prediction result obtained by inputting the first data into a machine learning model.

(b) The apparatus for presenting the determination result refers to information associating a second contribution of second data including multiple factors to a second prediction result obtained by inputting the second data into the machine learning model with a determination result by the user on the second prediction result. Further, the apparatus for presenting the determination result calculates the similarity between a third contribution, which is obtained by adjusting the calculated first contribution according to a focus factor of the second contribution, and a fourth contribution, which is obtained by adjusting the second contribution according to the focus factor.

(c) The apparatus for presenting the determination result controls a priory of a determination result to be presented among multiple determination results included in the information on the basis of the calculated similarity.

As described above, the apparatus for presenting the determination result can present a determination result by the user on the fourth contribution similar to the third contribution, for example. For example, the apparatus for presenting the determination result can present the determination result on the fourth contribution similar to the third contribution adjusted according to the focus factor to the user, for example, by reading the determination result from the information that accumulates the past determination results.

This allows the apparatus for presenting the determination result to present appropriate information to be used for the user's decision making based on a prediction result of the machine learning model. Consequently, the labor of the user to read the explanation result to a prediction result can be reduced.

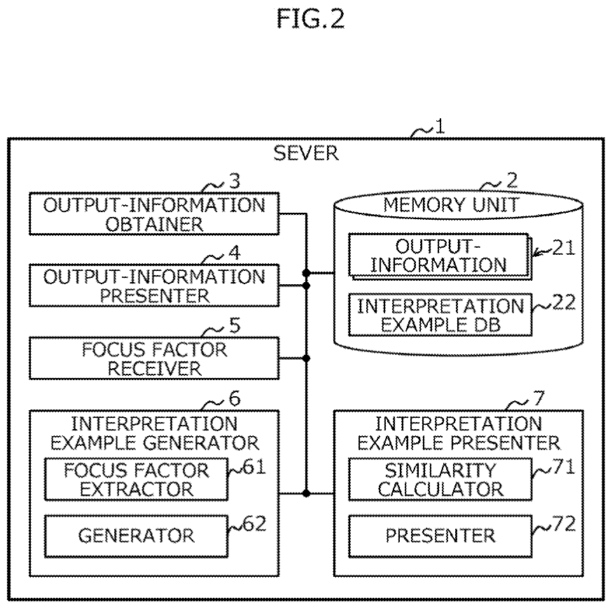

FIG. 2 is a block diagram schematically illustrating an example of the functional configuration of a server 1 according to the embodiment. The server 1 is an example of the apparatus for presenting the determination result that presents a determination result as information to be used in the user's decision making based on a prediction result of a machine learning model. As illustrated in FIG. 2, the server 1 may illustratively include a memory unit 2, an output-information obtainer 3, an output-information presenter 4, a focus factor receiver 5, an interpretation example generator 6, and an interpretation example presenter 7. The output-information obtainer 3, the output-information presenter 4, the focus factor receiver 5, the interpretation example generator 6, and the interpretation example presenter 7 collectively serve as an example of a controller.

The memory unit 2 is an example of a storage area and stores various types of data that the server 1 uses. As illustrated in FIG. 2, the memory unit 2 may illustratively be capable of storing multiple pieces of output-information 21 and an interpretation example Database (DB) 22.

The output-information 21 is information outputted by a machine learning apparatus provided in the server 1 or outside the server 1, and may include, for example, a prediction result of the machine learning model and a factor contribution. The multiple pieces of the output-information 21 may be managed as a DB in which the prediction result and the corresponding one or more factor contributions are accumulated in association with each other for each input-data, for example.

The interpretation example DB 22 is a DB that accumulates interpretation examples that are examples of determination results by the user on past prediction results. The interpretation example DB 22, for example, may manage at least the factor contribution and the interpretation example of the output-information 21 in association with each other. In other words, the information managed by the interpretation example DB 22 is an example of the information that associates the contributions with the determination results by the user.

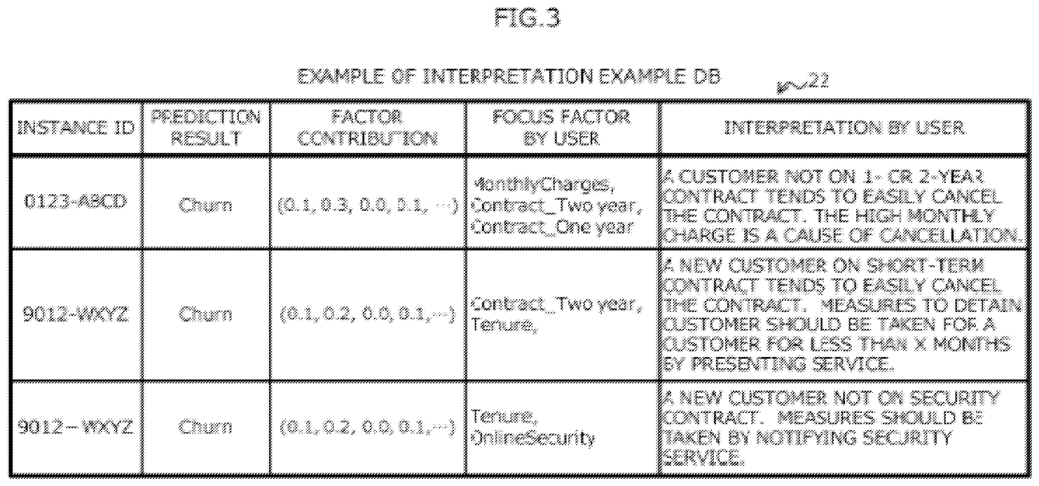

FIG. 3 is a diagram illustrating an example of the interpretation example DB 22 according to the embodiment. FIG. 3 illustrates the data format (data structure) of the interpretation example DB 22 in a table format, but is not limited to this. The interpretation example DB 22 may have any data format, such as a DB and an arrays.

As illustrated in FIG. 3, the interpretation example DB 22 may illustratively include items of “instance ID (Identifier)”, “prediction result”, “factor contribution”, “focus factor” by the user, and “interpretation” by the user.

The “instance ID” is an example of an identification information of an instance, in other words, the identification information of a prediction process based on input-data for each customer and/or contract.

The “prediction result” and the “factor contribution” are examples of the output-information 21. The “prediction result” may be, for example, a prediction result obtained by inputting data including multiple factors into a machine learning model. For example, a letter string may be set in the “prediction result” for a machine learning model that makes classification, and a real number may be set for a machine learning model that regresses. The “factor contribution” is an example of a contribution of the data to the prediction result.

In cases where the output-information 21 is stored in the form of, for example, a DB in the memory unit 2, the interpretation example DB 22 may set therein the output-information 21, i.e., information to specify a combination (set) of the prediction result and the factor contribution, in place of or in addition to the items of the “prediction result” and the “factor contribution”. The information includes, for example, an ID for specifying an entry in the DB.

The “focus factor” is information indicating one or more factors that the user focused on when determining the reason for the cancellation of a customer, in other words, the factors that the user focused on when reading the main factor that caused the cancellation. The “focus factor” may set therein a list of factor names of the focus factors. Incidentally, in the list, identification information or the like of the focus factors may be set in place of or in addition to the factor names.

The “interpretation” is information indicating one of or both of interpretation and evaluation related to one of or both of description related to one or more focus factors that the user focused on in determining a reason for cancellation of a customer and description related to the decision making based on the focus factors (e.g., description related to a measurement to detain the customer). In the “interpretation”, a text of these description may be set. Incidentally, in the “interpretation”, information or the like for specifying a location of storing the text may be set in place of or in addition to the text.

One of or both of the “focus factor” and the “interpretation” are an example of the interpretation example. For example, as illustrated in the entries on the second and third rows in the interpretation example DB 22 in FIG. 3, in cases where multiple users each interpret the same instance “9012-WXYZ”, the interpretation example DB 22 may accumulate entries (two in the example of FIG. 3) one for each of the interpretation examples of the users.

Returning to the explanation of FIG. 2, the output-information obtainer 3 obtains the output-information 21 and stores the obtained output-information 21 into the memory unit 2. For example, the output-information obtainer 3 may perform an inferring process by the machine learning model and obtain the output-information 21. In other words, the output-information obtainer 3 may calculate a first contribution of first data including multiple factors to a first prediction result obtained by inputting the first data into the machine learning model.

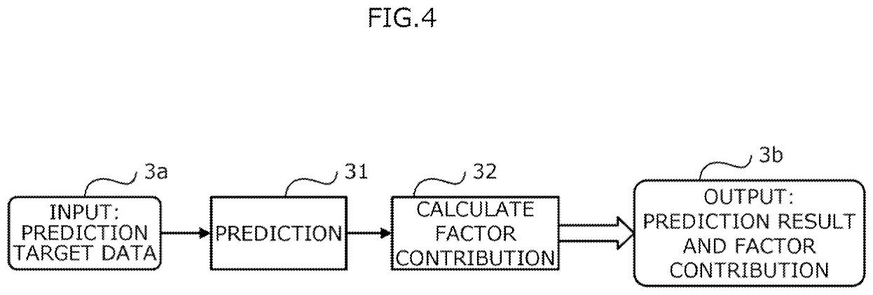

FIG. 4 is a diagram illustrating an example of an operation of the output-data obtainer 3. As an example, as illustrated in FIG. 4, the output-information obtainer 3 may perform a predicting process 31 using a trained machine learning model by using prediction target data as an input 3a. Further, the output-information obtainer 3 may perform a calculating process 32 of one or more factor contributions to the prediction result for each factor of the prediction target data, and output the output-information 21 including the prediction result and the factor contributions as an output 3b to the memory unit 2.

The calculating process 32 of the factor contribution may apply, for example, the method described in “Why Should I Trust You?” Explaining the Predictions of Any Classifier, Marco Tulio Ribeiro et al, arXiv:1602.04938v3 [cs.LG] 9 Aug. 2016″.

Instead of executing the process illustrated in FIG. 4, the output-information obtainer 3 may receive the output-information 21, including factor contributions and being outputted from a machine learning apparatus provided outside the server 1, through a non-illustrated network, for example, and store the output-information 21 in the memory unit 2.

Here, into the above-described interpretation example DB 22, the output-information 21 which has undergone determining a reason for an inferring result by the user and making decision by the user and which corresponds to the “prediction result” and the “factor contributions” in which information of interpretation and evaluation of the determination and the decision are set or are about to be set as the interpretation example is stored. In the following description, the target output-information 21 to be stored in the interpretation example DB 22 may be referred to as “known output-information 21” which has undergone determination of a reason for an inferring result and decision making. Also, if the combination of the “prediction result” and the “factor contribution” corresponds to one instance, the “known output-information 21” may be referred to as “known instance”.

In other words, the interpretation example DB 22 is an example of information associating a second contribution of second data including multiple factors to a second prediction result obtained by inputting the second data into the machine learning model with a determination result by the user on the second prediction result.

On the other hand, the output-information 21 of which the interpretation example is not set in the interpretation example DB 22 is the output-information 21 which has not undergone determination of a reason for an inferring result and decision making (which means that which is about to undergo determination of a reason for an inferring result and decision making). In the following description, the output-information 21 of which the interpretation example is not set in the interpretation example DB 22 may be referred to as “unknown output-information 21” or “unknown instance” which has not undergone determination of a reason for an inferring result and decision making.

Returning to the explanation of FIG. 2, the output-information presenter 4, the focus factor receiver 5, and the interpretation example generator 6 cooperatively execute an interpretation example accumulating process that creates and updates the interpretation example DB 22. Incidentally, the interpretation example DB 22 may be updated by an interpretation example presenting process in which the interpretation example presenter 7 to be detailed below presents the interpretation example on the basis of the interpretation example DB 22. Accordingly, the interpretation example accumulating process may be executed in accordance with the interpretation example presenting process in addition to building or updating the interpretation example DB 22. Hereinafter, description will now be made in relation to the interpretation example accumulating process when the interpretation example DB 22 is to be built or updated, and another interpretation example accumulating process executed according to the interpretation example presenting process will be described below.

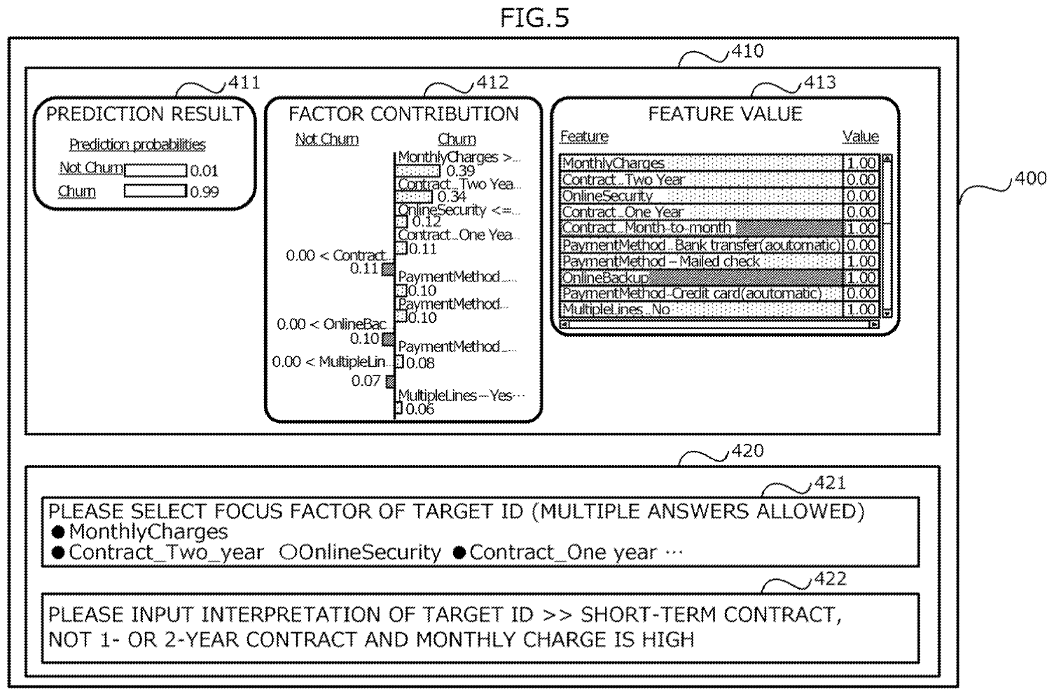

The output-information presenter 4 presents a presenting screen 400, illustrated in FIG. 5, to the user to set a determination result on the output-information 21.

FIG. 5 is a diagram illustrating an example of the presenting screen 400. As illustrated in FIG. 5, the presenting screen 400 may include a presenting area 410 of a prediction result, a factor contribution and a feature value, and an input area 420 for encouraging the user in inputting the “focus factor” and the “interpretation”.

The presenting area 410 may include a presenting area 411 of a prediction result, a presenting area 412 of factor contributions, and a presenting area 413 of a feature value for a known output-information 21.

The input area 420 is an area for obtaining the interpretation example, which is an example of a determination result by the user. For example, the input area 420 may include an input area 421 of a focus factor and an input area 422 of an interpretation.

The input area 421 is an area for encouraging the user in inputting the factors (focus factors) focused by the user in relation to the known output-information 21 displayed on the presenting area 410.

For example, as illustrated in FIG. 5, the output-information presenter 4 may display a list of factor contributions of the output-information 21 on the input area 421 in such a manner that the user can specify (select) one or more factor contributions. The number of factor contributions displayed on the input area 421, for example, may be limited to top x (x is an integer of two or more) from the highest factor contribution. Note that, the list may be displayed on the input area 421 in such a manner that the focus factors can be ranked, in other words, in such a manner that the focus degree of each focus factor can be set.

The input area 422 is an area for encouraging the user in inputting the interpretation by the user on the basis of the known output-information 21 displayed in the presenting area 410.

For example, as illustrated in FIG. 5, into the input area 422, the user may be allowed to input an interpretation of one of or both of a reason for an inferring result read by the user and the decision determined by the user in a free format. Into the input area 422, information that can specify a focus factor may be input.

As the above, into the input area 420, a determination result may be inputted in such a manner that one or more factors that the user focused can be specified or estimated. In the presenting screen 400, one of the input areas 421 and 422 may be omitted.

The output-information presenter 4 may, for example, obtain an output-information 21 (e.g., the known output-information 21) of which the interpretation example is not set in the interpretation example DB 22 from the memory unit 2 and output screen information of the presenting screen 400 for displaying the output-information 21. The screen information may be displayed on a display device included in the server 1, for example, or may be transmitted to a terminal device of the user connected to the server 1 through a network and displayed on a display device included in the terminal device.

The focus factor receiver 5 receives an input from the user directed to the input area 420 of the presenting screen 400. For example, the focus factor receiver 5 obtains information (e.g., one of or both of a specified focus factor and the input interpretation) related to the focus factor input into the input area 420 from the server 1 or the terminal device of the user, and outputs the obtained information to the interpretation example generator 6. For example, the focus factor receiver 5 may receive an input from the user directed to the input area 420 in response to detection of depressing of a button (not illustrated) for register an input content into the input area 420 displayed on the presenting screen 400.

The interpretation example generator 6 generates an interpretation example based on the information obtained by the focus factor receiver 5, and generates and updates the interpretation example DB 22. The interpretation example generator 6 may include a focus factor extractor 61 and a generator 62, as illustrated in FIG. 2.

The focus factor extractor 61 analyzes the information input into the input area 422, for example, the text, and extracts a focus factor from the text. By way of example, the focus factor extractor 61 may search in the text for one or more factors consistent with or similar to a factor contribution displayed in the presenting area 410 and/or identify one or more factors similar to a factor contribution displayed in the presenting area 410 by natural language process, on the text.

In cases where the input area 422 is not displayed on the presenting screen 400, or in cases where no text is input into the input area 422, a configuration in which the interpretation example generator 6 is not provided with the focus factor extractor 61 may be allowed.

When accumulating the known output-information 21, e.g., the known prediction result, as past data, into the interpretation example DB 22, the generator 62 accumulates a determination result by the user in the interpretation example DB 22 in association with a prediction result.

For example, as illustrated in FIG. 3, the generator 62 adds an entry to the interpretation example DB 22 and registers, into the entry, a set that associates a prediction result and one or more factor contributions displayed in the presenting area 410 with an interpretation example by the user obtained by the focus factor receiver 5 and the focus factor extractor 61.

As the above, the output-information presenter 4, the focus factor receiver 5, and the interpretation example generator 6 cooperatively generate the above-described interpretation example for each output-information 21 in the interpretation example accumulating process and accumulates (adds) the generated interpretation example into the interpretation example DB 22.

When the user is determining a reason for an inferring result and making decision on unknown output-information 21 in the interpretation example presenting process, the interpretation example presenter 7 presents, as a similar example, the output-information 21 having a factor contribution similar to that of the unknown output-information 21 from the interpretation example DB 22. At this time, the interpretation example presenter 7 presents a similar example considering the interpretation by the user and also presents one or more accumulated interpretation examples. As illustrated in FIG. 2, the interpretation example presenter 7 may include a similarity calculator 71 and a presenter 72. Hereinafter, description will now be made in relation to the interpretation example presenting process performed by the interpretation example presenter 7.

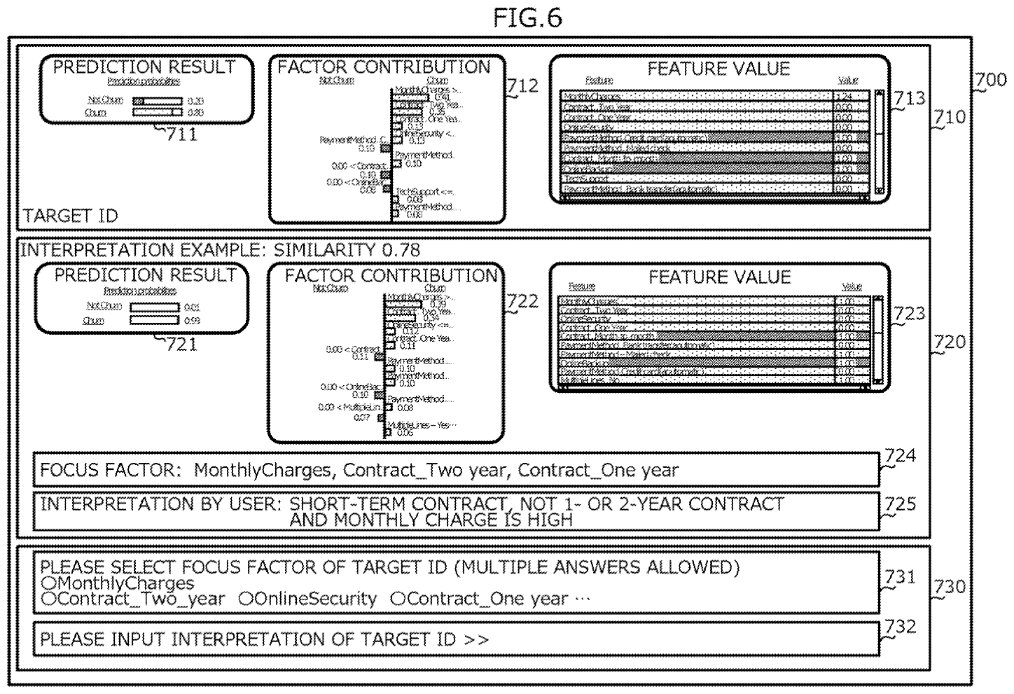

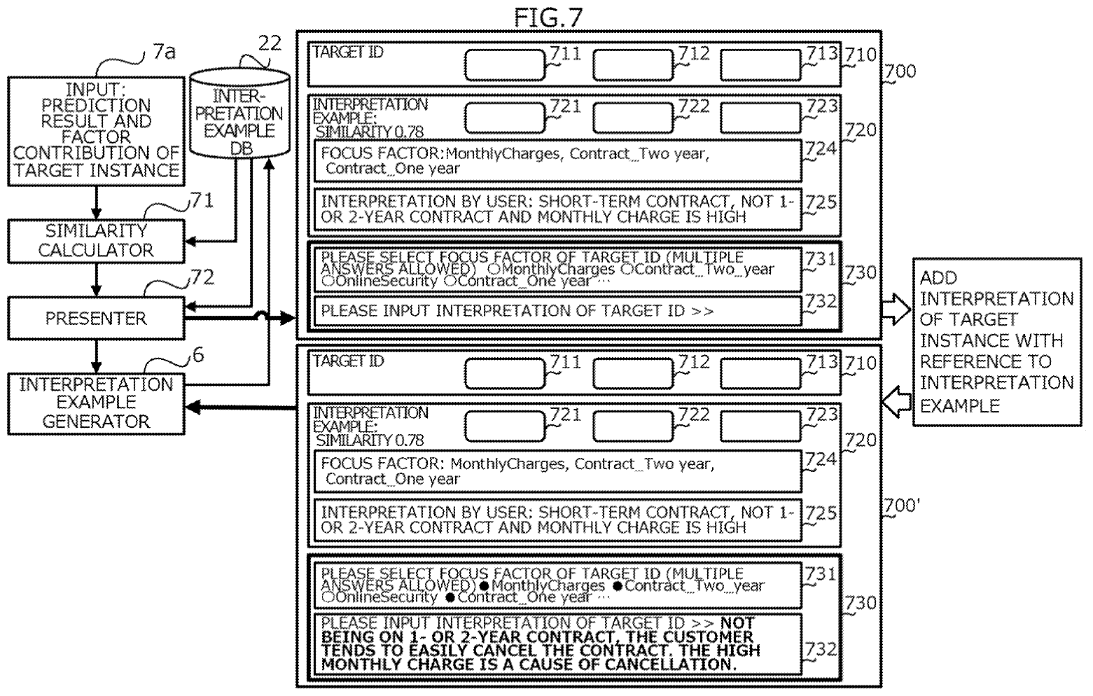

FIG. 6 is a diagram illustrating an example of a presenting screen 700 by the interpretation example presenter 7, and FIG. 7 is a diagram illustrating an example of the interpretation example presenting process. In FIG. 7, illustrations in the areas indicated by reference numbers 711 to 713 and 721 to 723 are omitted.

The similarity calculator 71 calculates a similarity between the unknown output-information 21 (unknown data; registration target data) to be registered in the DB 22, in other words, the unknown instance, and the each output-information 21 (each known data) that the interpretation example DB 22 stores, in other words, the known instance. In the example of FIG. 7, the similarity calculator 71 obtains a prediction result and one or more factor contributions (in other words, the important factors) of the target instance as an input 7a.

For example, the similarity calculator 71 may calculate factor-contribution vectors of the respective instances based on factor contributions and calculate the similarity between such factor-contribution vectors as the similarity between instances. The similarity between the factor-contribution vectors may be calculated using any known techniques for obtaining the similarity (e.g., distance) of vector spaces such as Euclidean distance, cosine similarity.

Here, in the calculating of the similarity between the instances, the similarity calculator 71 according to the embodiment may weight the factor-contribution vectors of the unknown and known instances used in the calculation on the basis of the focus factor of the known output-information 21.

As an example, the similarity calculator 71 calculates vectors w_{T} and w_{D} respectively by weighting the factor-contribution vector V_{T} of the unknown instance T and the factor-contribution vector V_{D} of the known instance D with the factor contribution corresponding to the focus factor of the known instance D.

Any known method can be applied to a method of weighting the factor-contribution vectors V_{T} and V_{D}, but the embodiment assumes to accomplish the weighting by, for example, multiplying a factor contribution associated with a focus factor of the known instance D by a weighting coefficient α (α is a given integer or real number).

For example, the similarity calculator 71 may calculate a weighted factor-contribution vector w_{T} based on a weighted factor contribution that is weighted by multiplying a factor contribution that matches the focus factor of the known instance D among the factor contributions of the unknown instance T by α.

As an example, the focus factors of the known instance D are assumed to be the second and fourth factors. In cases where the factor contributions of the unknown instance T are “0.1, 0.3, 0.0, 0.1, . . . ”, the similarity calculator 71 may calculate the weighted factor-contribution vector w_{T} based on the weights “0.1, 0.3×α, 0.0, 0.1×α, . . . ” obtained by multiplying the factor contributions associated with the focus factors by a coefficient α. The factor contributions of the unknown instance T exemplified by “0.1, 0.3, 0.0, 0.1, . . . ” are examples of the first contribution of the first data including multiple factors to the first prediction result obtained by inputting the first data into the machine learning model. The weighted factor contributions exemplified by “0.1, 0.3×α, 0.0, 0.1×α, . . . ” are examples of the third contribution obtained by adjusting the first contribution according to a focus factor of the second contribution to be detailed below.

Furthermore, the similarity calculator 71 may calculate a weighted factor-contribution vector w_{D} based on a weighted factor contribution that is weighted by multiplying a factor contribution that matches the focus factor of the known instance D among the factor contributions of the known instance D by a.

As an example, the focus factors of the known instance D are assumed to be the second and fourth factors. In cases where the factor contributions of the known instance D are “0.1, 0.2, 0.0, 0.1, . . . ”, the similarity calculator 71 may calculate the weighted factor-contribution vector w_{D} based on the weights “0.1, 0.2×α, 0.0, 0.1×α, . . . ” obtained by multiplying the factor contributions associated with the focus factors by a coefficient α. The factor contributions of the known instance D exemplified by “0.1, 0.2, 0.0, 0.1, . . . ” are examples of the second contribution of the second data including multiple factors to the second prediction result obtained by inputting the second data into the machine learning model. The weighted factor-contributions exemplified by “0.1, 0.2×α, 0.0, 0.1×α, . . . ” are examples of the fourth contribution obtained by adjusting the second contribution according to a focus factor of the second contribution.

The focus factors of the known instance D are specified for each known instance D and registered into the interpretation example DB 22. For this reason, the factor contributions weighted in the calculation of a weighted factor-contribution vector w_{T} are different with the known instances D of which similarity is to be calculated. Accordingly, the similarity calculator 71 may calculate the weighted factor-contribution vectors w_{T} and w_{D} for a set of the unknown instance T of which similarity is to be calculated and each of multiple known instances D.

The coefficient α may be set as the first coefficient α₁ for the unknown instance T and the second coefficient α₂ for the known instance D. The first coefficient α₁ and the second coefficient α₂ may be the same value or different values. Further, the coefficient α may be the common value to or different values with the known instances D used for calculating a similarity with the unknown instance T. Furthermore, in cases where multiple focus factors are present, the coefficient α may be a larger (or smaller) value as the degree of focus (if set) of each focus factor is higher.

The similarity calculator 71 may also record, for example, one of or both of the weighted factor contribution and the weighted factor-contribution vector w_{D}, which are calculated for the unknown instance T and the known instance D, into the memory unit 2, e.g., the interpretation example DB 22. This can simplify or omit, for example, a calculating process of the factor-contribution vector w_{D} for the known instance D accumulated in the interpretation example DB 22 for the second and the subsequent times.

In the following description assumes that the known instance D of which similarity with the unknown instance T is to be calculated is all the instances D stored in the interpretation example DB 22. In other words, the similarity calculator 71 may calculate the similarity of a combination of the first contribution and each of the multiple second contributions stored in the interpretation example DB 22.

The manner of calculating the similarity is not limited to one described above, and alternatively, the known instance D of which similarity with the unknown instance T is to be calculated may be limited to, for example, an instance D having a prediction result similar to that of the unknown instance T among the multiple instances D stored in the interpretation example DB 22. In other words, the similarity calculator 71 may calculate the similarity for a combination of the first contribution and each of the second contributions having the second prediction result similar to the first prediction result among the multiple second contributions stored in the interpretation example DB 22. The interpretation example of the known instance D having a prediction result similar to the prediction result of the target instance T has a high possibility of being useful (helpful) to the user in the decision making on the target instance T. Therefore, limiting the known instances D used for calculating the similarity can reduce the processing load, leaving appropriate known instances D for the calculation of the similarity.

As described above, the similarity calculator 71 calculates the similarity between the unknown target instance T and the known instance D after the factor contributions associated with the focus factors of the known output-information 21 is weighted for each known output-information 21.

The presenter 72 controls, based on the similarity calculated by the similarity calculator 71, the priority of the determination result to be presented among multiple determination results contained in the interpretation example DB 22. For example, the presenter 72 presents an interpretation example for a known instance (sometimes referred to as a “similar instance”) having a high similarity with an unknown instance by using, for example, the presenting screen 700 illustrated in FIGS. 6 and 7, on the basis of the similarity calculated by the similarity calculator 71. One or more interpretation examples may be presented on the presenting screen 700. The priority of the determination result may include, for example, the order of presenting interpretation examples on the presenting screen 700, the position of presenting the interpretation example, or the priority of whether to present or omit (not to present) the interpretation example.

For example, the presenter 72 may present interpretation examples of the top Y (Y is an integral number) similar instances extracted in order of higher similarity, and may present an interpretation example of a similar instance having a similarity of equal to or greater than a threshold value. Alternatively, the presenter 72 may present interpretation examples of the top Y similar instances extracted in descending order from the highest similarity among similar instances each having similarity of equal to or greater than a threshold value.

As illustrated in FIG. 6, the presenting screen 700 may illustratively include presenting areas 710 and 720 and an input area 730.

The presenting area 710 is an area for displaying a prediction result, a factor contribution, and a feature value of an unknown instance (unknown data) and may include a presenting area 711 of a prediction result, a presenting area 712 of a factor contribution, and a presenting area 713 of a feature value in relation to the output-information 21 of the unknown data.

The presenting area 720 is an area for displaying a prediction result, a factor contribution, a feature value, and an interpretation example of a known instance (known data, similar data) similar to the unknown instance. Further, the presenting area 720 may display a calculated similarity (“0.78” in the example of FIG. 6) between the known instance and the unknown instance. The presenting area 720 may include a presenting area 721 of a prediction result, a presenting area 722 of a factor contribution, a presenting area 723 of a feature value, a presenting area 724 of a focus factor, and a presenting area 725 of an interpretation in the output-information 21 of similar data.

For example, the presenter 72 may extract information of the “focus factor” of the similar data from the interpretation example DB 22 and display the extracted information in the presenting area 724. The presenter 72 may also extract information of the “interpretation” of the similar data from the interpretation example DB 22 and display the extracted information in the presenting area 725.

The example of FIG. 6 assumes that the presenting area 720 for displaying one known instance as a similar interpretation example is included in the presenting screen 700, which is however not limited to this. Alternatively, the presenting screen 700 may include multiple presenting areas 720 displaying respective interpretation examples of multiple known instances similar to the unknown instance.

The input area 730 is an area for encouraging the user in inputting the “focus factor” and the “interpretation” related to the unknown instance, and is an area for obtaining the interpretation example, which is an example of a determination result of the user. For example, the input area 730 may include an input area 731 of a focus factor and an input area 732 of an interpretation. In the example of FIG. 6, an interpretation example of the user is not input (not set) in the input area 730.

The input area 731 is an area for encouraging the user in inputting (setting) focus factors focused by the user in relation to unknown output-information 21 displayed on the presenting area 710.

For example, as illustrated in FIG. 6, the presenter 72 may display a list of factor contributions of the unknown instance in the input area 731 in such a manner that the user is allowed to specify (select) one or more factor contributions. The number of factor contributions displayed on the input area 731, for example, may be limited to top x from the highest factor contribution. Note that, a list may be displayed in the input area 731 in such a manner that the focus factors can be ranked, in other words, in such a manner that the degree of focus of each focus factor can be set.

The input area 732 is an area for encouraging the user in inputting an interpretation of the user on the basis of the unknown output-information 21 displayed in the presenting area 710.

For example, as illustrated in FIG. 6, into the input area 732, the user may be allowed to input an interpretation of one of or both of the reason for an inferring result read by the user and the decision made by the user in a free format. Into the input area 732, information that can specify a focus factor may be input.

As the above, into the input area 730, a determination result may input in such a manner that one or more factors that the user focused can be specified or estimated. In the presenting screen 700, one of the input areas 731 and 732 may be omitted.

For example, as illustrated in FIG. 7, the user can input (add) an interpretation of the target instance to the input area 730 by referring to the interpretation example displayed in the presenting area 720 of the interpretation example in the presenting screen 700. In FIG. 7, the presenting screen 700 in which the interpretation of the target instance has been added is referred to as a presenting screen 700′. The presenting screen 700′ illustrates an example in which factors of “MonthlyCharges”, “Contract_Two_year”, and “Contract_One_year” are designated as focus factors in the input area 731. In addition, the presenting screen 700′ illustrates an example that the user inputs an interpretation that “not being on 1- or 2-year contract, the customer tends to easily cancel the contract. The high monthly change is a cause of the cancellation.” into the input area 732.

As described above, in the server 1 according to the embodiment, the interpretation example presenter 7 can present an interpretation example of the similar instance to the user by calculating the similarity in which the weight is considered from the interpretation example DB 22, using the prediction result of the unknown data and the factor contribution of the unknown data as an input. In other words, when encouraging the user in inputting an interpretation of target data, the server 1 can present a similar example considering one or more focus factors from among interpretations made by the user or other users on past data.

Therefore, by referring to the interpretation example of the similar instance displayed in the presenting area 720 of the presenting screen 700, the user can reduce the time and effort to interpret which factor of factor contributions for the unknown instance is the main factor for a reason for an inferring result and decision making of the user.

Here, a button (not illustrated) for registering the input content into the input area 730 may be displayed on the presenting screen 700.

The focus factor receiver 5 may receive an input from the user directed to the input area 730 in response to detection of depressing of the button in the presenting screen 700. This means that the focus factor receiver 5 and the interpretation example generator 6 may cooperatively perform an interpretation example accumulating process based on the content inputted into the input area 730 in the interpretation example presenting process.

For example, the focus factor receiver 5 obtains information (e.g., one of or both of a specified focus factor and the input interpretation) related to the focus factor input into the input area 730 from the server 1 or the terminal device of the user, and outputs the obtained information to the interpretation example generator 6.

The interpretation example generator 6 generates an interpretation example based on the information obtained by the focus factor receiver 5, and updates the interpretation example DB 22.

For example, the focus factor extractor 61 analyzes the information input into the input area 732, for example, the text, and extracts a focus factor from the text. By way of example, the focus factor extractor 61 may search in the text for one or more factors consistent with or similar to a factor contribution displayed in the presenting area 710 and/or identify one or more factors similar to a factor contribution displayed in the presenting area 710 by natural language process, on the text.

In cases where the input area 732 is not displayed on the presenting screen 700, or in cases where no text is input into the input area 732, a configuration in which the interpretation example generator 6 is not provided with the focus factor extractor 61 may be allowed.

As illustrated in FIG. 7, when accumulating, as the past data, the prediction result of the target instance in the presenting area 710 into the interpretation example DB 22, the generator 62 accumulates the determination result by the user in the interpretation example DB 22 in association with the prediction result.

For example, as illustrated in FIG. 3, the generator 62 adds an entry to the interpretation example DB 22 and registers, into the entry, a set that associates the prediction result and the factor contribution displayed in the presenting area 710 with the interpretation example of the user obtained by the focus factor receiver 5 and the focus factor extractor 61.

As described above, the focus factor receiver 5, the interpretation example generator 6, and the interpretation example presenter 7 cooperatively generates the interpretation example described above of each the unknown output-information 21 in the interpretation example presenting process, and accumulates (adds) the generated interpretation example to the interpretation example DB 22.

Thereby, the server 1 can accumulate interpretation examples inputted in relation to a target instance into the interpretation example DB 22, as candidates for a similar instance in the next and subsequent interpretation example presenting process. Accordingly, the number of candidates for interpretation examples to be presented to the user can be increased, so that the likelihood to present appropriate information that can be used for user's decision making can be enhanced.

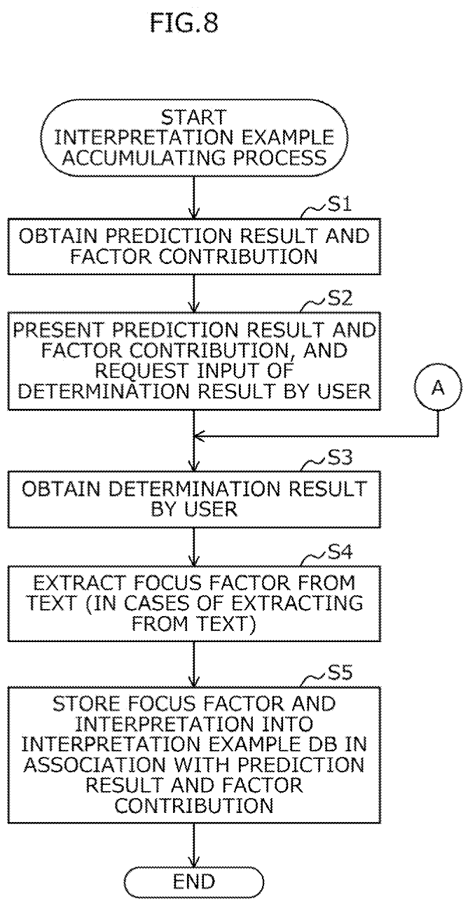

Hereinafter, description will now be made in relation to examples of operations of the interpretation example accumulating process and the interpretation example presenting process performed by the server 1 with reference to FIGS. 8 to 10.

FIG. 8 is a flowchart illustrating an example of an operation of the interpretation example accumulating process performed by the server 1 according to the embodiment. As illustrated in FIG. 8, the output-information obtainer 3 of the server 1 obtains a prediction result and one or more factor contributions of a known instance (Step S1). The factor contributions may each contain or be attached with a feature value.

The input-information presenter 4 presents the prediction result and the factor contributions obtained by the output-information obtainer 3 on the presenting screen 400 (see FIG. 5), and requests for an input of the determination result by the user (Step S2).

The focus factor receiver 5 obtains the determination result by the user input into the input areas 421 and 422 of the presenting screen 400, which result is exemplified by information indicating a focus factor and information indicating an interpretation (Step S3). Further, when extracting a focus factor from the text in the input area 422 of the presenting screen 400, the focus factor extractor 61 of the interpretation example generator 6 extracts the information indicating the focus factor from the text inputted in the input area 422 (Step S4).

The generator 62 stores the focus factor and the interpretation that are obtained by the focus factor receiver 5 and the focus factor extractor 61 into the interpretation example DB 22 in association with the prediction result and the factor contribution obtained in Step S1 (or Step S11 to be described below) (Step S5), and then the process ends.

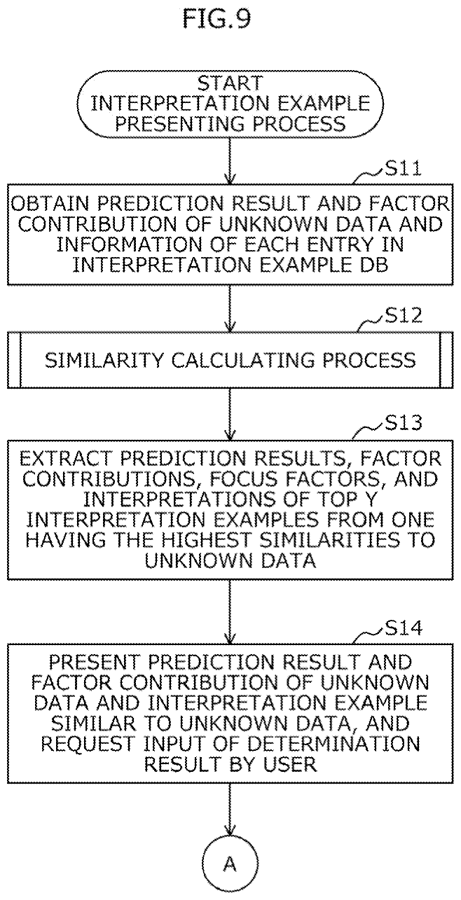

FIG. 9 is a flowchart illustrating an example of an operation of the interpretation example presenting process performed by the server 1 according to the embodiment. As illustrated in FIG. 9, the similarity calculator 71 of the interpretation example presenter 7 obtains a prediction result and one or more factor contributions of an unknown data (target instances) and data (each instance) in the interpretation example DB 22 (Step S11), and performs a similarity calculating process (Step S12).

On the basis of the similarity between the unknown data and each known data which the similarity has been calculated by the interpretation example presenter 7, the presenter 72 extracts, as the interpretation examples, prediction results, factor contributions, focus factors, and interpretations of the top Y interpretation examples from the highest similarity with the unknown data from the interpretation example DB 22 (Step S13).

The presenter 72 presents the prediction result and the factor contribution of the unknown data obtained in Step S11 and the one or more interpretation examples similar to the unknown data extracted in Step S13 to the presenting screen 700 (see FIG. 6) and requests the user to input the determination result by the user (Step S14). Then, the process proceeds to Step S3 of FIG. 8.

This means that the focus factor receiver 5 and the interpretation example generator 6 may obtain the determination result by the user with reference to the information inputted into the input area 730 of the presenting screen 700, and store the determination result into the interpretation example DB 22 in association with the one or more focus factors and the prediction result of the unknown data.

Alternatively, in Step S14, the presenter 72 may simply display the prediction result, the one or more factor contributions of the unknown data, and the interpretation example on the presenting screen 700 and end the process by the interpretation example presenter 7. In other words, the presenter 72 may only provide the user with information that is to be used in determining a reason for an inferring result and in decision making in relation to the unknown data.

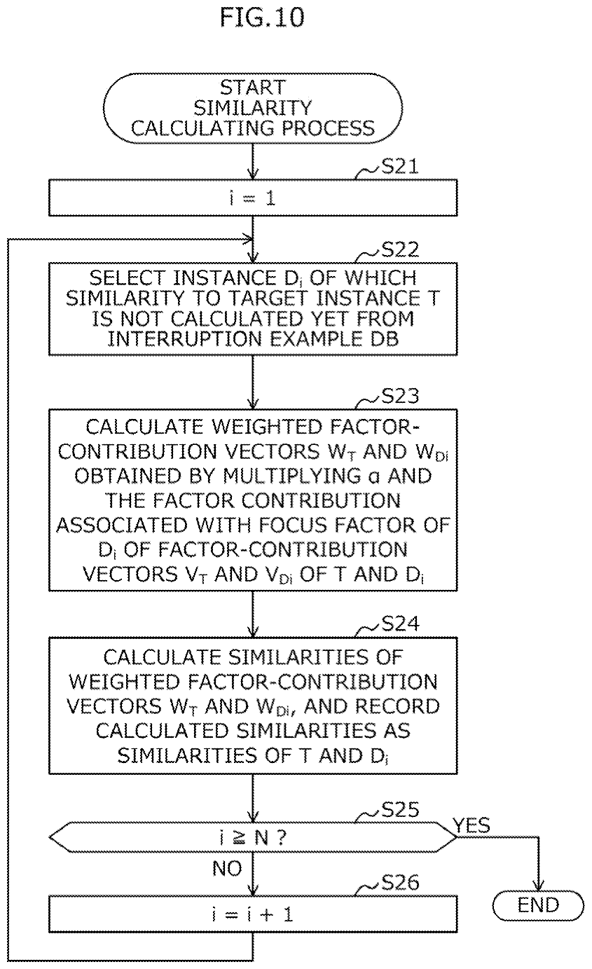

Next, description will now be made in relation to an example of an operation example of the similarity calculating process in Step S12 of FIG. 9 with reference to FIG. 10. FIG. 10 is a flowchart illustrating an example of an operation of the similarity calculating process. The following explanation assumes that the prediction result and the factor contributions of the target instance (unknown data), and the information of the respective entries in the interpretation example DB 22 are obtained by the similarity calculator 71 in Step S11 of FIG. 9.

As illustrated in FIG. 10, the similarity calculator 71 initializes the variable i to 1 (Step S21), for example, and selects an instance Dᵢ of which similarity with the target instance T is not calculated from the interpretation example DB 22 (Step S22).

The similarity calculator 71 calculates weighted contribution-factor vectors w_{T} and w_{Di} for the factor-contribution vectors V_{T} and V_{Di} of the instances T and Dᵢ by multiplying the factor contribution associate with the focus factor of the instance Dᵢ in the interpretation example DB 22 by the coefficient α (Step S23). In cases where the weighted factor-contribution vector w_{Di} is stored in the interpretation example DB 22, the calculation of the weighted factor-contribution vector w_{Di} may be omitted in Step S23. Alternatively, in cases where the weighted factor contribution of the instance Dᵢ is stored in the interpretation example DB 22, the similarity calculator 71 may only calculate a weighted factor-contribution vector w_{Di} based on the stored weighted factor-contribution, for example.

The presenter 72 calculates the similarity between the weighted factor-contribution vectors w_{T} and w_{Di} and records the calculated similarity into the memory unit 2 as the similarity between the instances T and Dᵢ (Step S24).

The similarity calculator 71 determines whether i≥N is satisfied (Step S25), and when not i≥N (e.g., if i N) (NO in Step S25), adds one to i (increment) (Step S26) and proceeds the process to Step S22. When i≥N (YES in Step S25), the process ends.

The symbol N represents the total number of known instances D of which similarities to the target instance T is to be calculated and which correspond to all the instances included in the interpretation example DB 22, for example. Alternatively, the symbol N may be, for example, the total number of instances each having a prediction result similar to the prediction result of the unknown instance among the instances included in the interpretation example DB 22.

The server 1 according to the embodiment may be a virtual server (Virtual Machine (VM)) or a physical server. The functions of the server 1 may be achieved by one computer or by two or more computers. Further, at least some of the functions of the server 1 may be implemented using Hardware (HW) resources and Network (NW) resources provided by cloud environment.

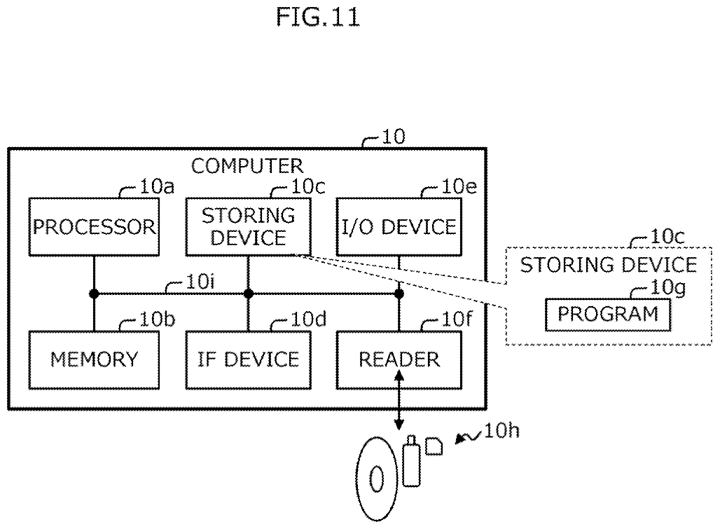

FIG. 11 is a block diagram schematically illustrating an example of a hardware (HW) configuration of a computer 10 that achieves the functions of the server 1. If multiple computers are used as the HW resources for achieving the functions of the server 1, each of the computers may include the HW configuration illustrated in FIG. 11.

As illustrated in FIG. 11, as the HW configuration, the computer 10 may illustratively include a processor 10a, a memory 10b, a storing device 10c, an interface (IF) device 10d, an Input/Output (I/O) device 10e, and a reader 10f.

The processor 10a is an example of an arithmetic operation processor that performs various controls and arithmetic operations. The processor 10a may be communicably connected to the blocks in the computer 10 via a bus 10i. The processor 10a may be a multiprocessor including multiple processors, may be a multicore processor having multiple processor cores, or may have a configuration having multiple multicore processors.

Examples of the processor 10a include an integrated circuit (IC) such as a Central Processing Unit (CPU), a Micro Processing Unit (MPU), a Graphics Processing Unit (GPU), an Accelerated Processing Unit (APU), a Digital Signal Processor (DSP), an Application Specific IC (ASIC), and a Field-Programmable Gate Array (FPGA). The processor 10a may be a combination consisting of two or more of these ICs.

The memory 10b is an example of a HW device that stores various types of data and information such as a program. Examples of the memory 10b include one of or both of a volatile memory such as a Dynamic Random Access Memory (DRAM) and a non-volatile memory such as Persistent Memory (PM).

The storing device 10c is an example of a HW device that stores various types of data and information such as program. Examples of the storing device 10c include a magnetic disk device such as a Hard Disk Drive (HDD), a semiconductor drive device such as a Solid State Drive (SSD), and various storing devices such as a nonvolatile memory. Examples of the non-volatile memory include a flash memory, a Storage Class Memory (SCM), and a Read Only Memory (ROM).

The memory unit 2 illustrated in FIG. 2 may be achieved by at least one storing region of the memory 10b and the storing device 10c. This means that the output-information 21 and the interpretation example DB 22 may each be stored in at least one of the storing region of the memory 10b and the storing device 10c.

The storing device 10c may store a program log (decision result presenting program) that implements all or part of various functions of the computer 10.

For example, the processor 10a of the server 1 can achieve the function as the server 1 (e.g., the memory unit 2, the output-information obtainer 3, the output-information presenter 4, the focus factor receiver 5, the interpretation example generator 6, and the interpretation example presenter 7) illustrated in FIG. 2 by expanding the program log stored in the storing device 10c into the memory 10b and executing the expanded program 10g.

The IF device 10d is an example of a communication IF that controls connection and communication with a network. For example, the IF device 10d may include an adapter complying with a Local Area Network (LAN) such as Ethernet (registered trademark) or optical communication such as a Fibre Channel (FC). The adapter may be compatible with one of or both of wireless and wired communication schemes.

For example, the server 1 may be communicably connected to non-illustrated computers such as a machine learning apparatus and a user terminal apparatus through the IF device 10d. For example, the output-information obtainer 3 may obtain the output-information 21 from the machine learning apparatus via a network. Additionally, the focus factor receiver 5 and the focus factor extractor 61 may obtain information input into the presenting screens 400 and 700 via the network, using the terminal apparatus. Furthermore, the program log may be downloaded to the computer 10 from the network through the communication IF and may be stored in the storing device 10c.

The I/O device 10e may include one of or both of an input device and an output device. Examples of the input device include a keyboard, a mouse, and a touch panel. Examples of the output device include a monitor, a projector, and a printer. For example, the output-information presenter 4 and the interpretation example presenter 7 illustrated in FIG. 2 may output and display the presenting screens 400 and 700 to and on the output device of the I/O device 10e.

The reader 10f is an example of a reader that reads data and programs recorded in the recording medium 10h. The reader 10f may include a connecting terminal or device to which the recording medium 10h can be connected or inserted. Examples of the reader 10f include an adapter conforming to, for example, Universal Serial Bus (USB), a drive apparatus that accesses a recording disk, and a card reader that accesses a flash memory such as an SD card. The program log may be stored in the recording medium 10h, and the reader 10f may read the program log from the recording medium 10h and store the read program 109 into the storing device 10c.

The recording medium 10h is example of a non-transitory computer-readable recording medium such as a magnetic/optical disk, and a flash memory. Examples of the magnetic/optical disk include a flexible disk, a Compact Disc (CD), a Digital Versatile Disc (DVD), a Blu-ray disk, and a Holographic Versatile Disc (HVD). Examples of the flash memory include a semiconductor memory such as a USB memory and an SD card.

The HW configuration of the computer 10 described above is exemplary. Accordingly, the computer 10 may appropriately undergo increase or decrease of HW devices (e.g., addition or deletion of arbitrary blocks), division, integration in an arbitrary combination, and addition or deletion of the bus. For example, the server 1 may omit at least one of the I/O device 10e and the reader 10f.

The technique according to the embodiment described above can be changed or modified as follows.

For example, the output-information obtainer 3, the output-information presenter 4, the focus factor receiver 5, the interpretation example generator 6, and the interpretation example presenter 7 included in the server 1 illustrated in FIG. 2 may be merged in any combination or divided respectively.

The server 1 illustrated in FIG. 2 may have a configuration that achieves each processing function by multiple apparatuses cooperating with each other via a network. By way of example, the memory unit 2 may be a DB server; the output-information obtainer 3 and the interpretation example generator 6 may be an application server; and the output-information presenter 4, the focus factor receiver 5, and she interpretation example presenter 7 may be a web server. In this case, the processing function as the server 1 may be achieved by the DB server, the application server, and the web server cooperating with one another via a network.

In one aspect, at least one of embodiments can present appropriate information to be used for an user's decision making based on a prediction result of a machine learning model.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein a determination result presenting program executable by one or more computers, the determination result presenting program comprising:
an instruction for calculating a first contribution of first data including a plurality of factors with respect to a first prediction result obtained by inputting the first data into a machine learning model;
an instruction for calculating, by referring to information associating a second contribution of second data including a plurality of factors with respect to a second prediction result with a determination result by a user on the second prediction result, a similarity between a third contribution and a fourth contribution, the second prediction result being obtained by inputting the second data into the machine learning model, the third contribution being obtained by adjusting the first contribution in accordance with a first factor identified by the determination result, the fourth contribution being obtained by adjusting the second contribution in accordance with the first factor; and
an instruction for controlling, based on the similarity, a priory of a determination result to be presented among a plurality of determination results included in the information.

2. The non-transitory computer-readable recording medium according to claim 1, wherein the determination result presenting program further comprising:
an instruction for obtaining a first determination result on the first prediction result; and
an instruction for storing the first contribution and the first determination result into the information in association with each other.

3. The non-transitory computer-readable recording medium according to claim 1, wherein the determination result presenting program further comprising:
an instruction for generating the information by obtaining the determination result on the second prediction result, as a second determination result, and storing the second contribution and the second determination result into the information in association with each other.

4. The non-transitory computer-readable recording medium according to claim 1, wherein
the first contribution includes a first plurality of factor contributions related to the plurality of factors included in the first data, respectively,
the second contribution includes a second plurality of factor contributions related to the plurality of factors included in the second data, and
the calculating of the similarity includes obtaining the third contribution by multiplying a first factor contribution of the first plurality of factor contributions related to the first factor with a first coefficient, and obtaining the fourth contribution by multiplying a second factor contribution of the second plurality of second factor contributions related to the first factor with a second coefficient.

5. The non-transitory computer-readable recording medium according to claim 1, wherein the calculating of the similarity includes calculating similarities between the first contribution and each of a plurality of contributions included in the information.

6. The non-transitory computer-readable recording medium according to claim 1, wherein the calculating of the similarity includes calculating similarities between the first contribution and each of one or more contributions with respect to one or more prediction results included in the information, the one or more prediction results being similar to the first prediction result.

7. A computer-implemented method for presenting a determination result, the method comprising:
calculating a first contribution of first data including a plurality of factors with respect to a first prediction result obtained by inputting the first data into a machine learning model;
calculating, by referring to information associating a second contribution of second data including a plurality of factors with respect to a second prediction result with a determination result by a user on the second prediction result, a similarity between a third contribution and a fourth contribution, the second prediction result being obtained by inputting the second data into the machine learning model, the third contribution being obtained by adjusting the first contribution in accordance with a first factor identified by the determination result, the fourth contribution being obtained by adjusting the second contribution in accordance with the first factor; and
controlling, based on the similarity, a priory of a determination result to be presented among a plurality of determination results included in the information.

8. The computer-implemented method according to claim 7, further comprising:
obtaining a first determination result on the first prediction result; and
storing the first contribution and the first determination result into the information in association with each other.

9. The computer-implemented method according to claim 7, further comprising:
generating the information by obtaining the determination result on the second prediction result, as a second determination result, and storing the second contribution and the second determination result into the information in association with each other.

10. The computer-implemented method according to claim 7, wherein
the first contribution includes a first plurality of factor contributions related to the plurality of factors included in the first data, respectively,
the second contribution includes a second plurality of factor contributions related to the plurality of factors included in the second data, and
the calculating of the similarity includes obtaining the third contribution by multiplying a first factor contribution of the first plurality of factor contributions related to the first factor with a first coefficient, and obtaining the fourth contribution by multiplying a second factor contribution of the second plurality of second factor contributions related to the first factor with a second coefficient.

11. The computer-implemented method according to claim 7, wherein the calculating of the similarity includes calculating similarities between the first contribution and each of a plurality of contributions included in the information.

12. The computer-implemented method according to claim 7, wherein the calculating of the similarity includes calculating similarities between the first contribution and each of one or more contributions with respect to one or more prediction results included in the information, the one or more prediction results being similar to the first prediction result.

13. An apparatus for presenting a determination result comprising:
a memory; and
a processor coupled to the memory, the processor being configured to
calculate a first contribution of first data including a plurality of factors with respect to a first prediction result obtained by inputting the first data into a machine learning model,
calculate, by referring to information associating a second contribution of second data including a plurality of factors with respect to a second prediction result with a determination result by a user on the second prediction result, a similarity between a third contribution and a fourth contribution, the second prediction result being obtained by inputting the second data into the machine learning model, the third contribution being obtained by adjusting the first contribution in accordance with a first factor identified by the determination result, the fourth contribution being obtained by adjusting the second contribution in accordance with the first factor, and
control, based on the similarity, a priory of a determination result to be presented among a plurality of determination results included in the information.

14. The apparatus according to claim 13, wherein the processor is further configured to
obtain a first determination result on the first prediction result, and
store the first contribution and the first determination result into the information in association with each other.

15. The apparatus according to claim 13, wherein the processor is further configured to
generate the information by obtaining the determination result on the second prediction result, as a second determination result, and storing the second contribution and the second determination result into the information in association with each other.

16. The apparatus according to claim 13, wherein
the first contribution includes a first plurality of factor contributions related to the plurality of factors included in the first data, respectively,
the second contribution includes a second plurality of factor contributions related to the plurality of factors included in the second data, and
the processor is further configured to obtain the third contribution by multiplying a first factor contribution of the first plurality of factor contributions related to the first factor with a first coefficient, and obtaining the fourth contribution by multiplying a second factor contribution of the second plurality of second factor contributions related to the first factor with a second coefficient.

17. The apparatus according to claim 13, wherein the similarity includes similarities between the first contribution and each of a plurality of contributions included in the information.

18. The apparatus according to claim 13, wherein the calculating of the similarity includes calculating similarities between the first contribution and each of one or more contributions with respect to one or more prediction results included in the information, the one or more prediction results being similar to the first prediction result.
